(19) United States
(12) Patent Application Publication
(10) Pub. No.: US 2026/0340064 A1
(43) Pub. Date: Oct. 29, 2026

(54) DATABASE OPTIMIZATION FOR READ QUERY CACHING

(71) Applicant: CAST AI Group, Inc., Miami, FL (US)

(72) Inventor: Luka Androjna, Ljubljana (SI)

(21) Appl. No.: 19/327,415

(22) Filed: Sep. 12, 2025

Related U.S. Application Data
(60) Provisional application No. 63/793,969, filed on Apr. 24, 2025.

(51) Int. Cl. G06F 16/957

(52) U.S. Cl. CPC G06F 16/9574

(57) ABSTRACT

A database optimization system receives a read query directed to a database and determine whether the read query matches an entry stored in a cache. In response to determining that the read query does not match any entry, the system forwards the query to the database and receives a corresponding result. The system evaluates whether the read query is cacheable based on repetition frequency. In response to determining that the read query is cacheable, the system stores the query and its result in the cache. Otherwise, the system bypasses storage of the result in the cache.

### CROSS REFERENCE TO RELATED APPLICATION

This application claims priority to U.S. Provisional Patent Application Ser. No. 63/793,969, filed Apr. 24, 2025, which is incorporated herein by reference in its entirety.

### TECHNICAL FIELD

This disclosure relates generally to database systems, and more specifically to database optimizations for read query caching and write query invalidation and eviction.

### BACKGROUND

Modern applications often rely on database caching to reduce query latency and minimize load on backend databases. A cache stores results of prior database queries so that repeated requests can be served quickly without re-executing the query against the underlying database. Conventional caching techniques, however, suffer from several inefficiencies that limit their effectiveness.

Various solutions apply simple policies such as least recently used (LRU) eviction to manage cache contents. As a result, cache space may be consumed by one-time or unstable queries that are unlikely to repeat or whose results change frequently. This misallocation of cache resources can displace queries that would provide higher performance benefit if cached, thereby reducing overall system efficiency.

Another challenge arises when write queries are executed. A write operation may alter data relied upon by previously cached read queries. Conventional systems often handle this either by broadly invalidating many cached entries—leading to unnecessary cache misses and redundant database calls—or by failing to invalidate all affected entries, thereby risking that stale or incorrect data is returned to users. These approaches either degrade performance or compromise correctness.

### SUMMARY

Embodiments described herein address the above described problems. For example, some embodiments described herein determine whether an incoming query is cacheable, selectively invalidate cached results upon write operations without unnecessary over-invalidation, and/or apply eviction policies that more intelligently retain queries with higher expected utility.

In some embodiments, a database optimization (DBO) system selectively caches results of read queries by first determining whether a query is cacheable. Cacheability may be evaluated using statistical rules or machine learning models, which consider factors such as query repetition frequency, stability of payloads, execution cost, payload size, and/or processing load. Machine learning models may further be trained on features extracted from SQL templates using natural language processing, and may be deployed in real-time or batch prediction modes. When a query is determined to be cacheable, its results are inserted into a cache; otherwise, the query is bypassed. Eviction policies are applied that extend beyond simple least-recently-used logic by incorporating predicted repetition likelihood to mitigate recency bias and retain queries of high value. Cached entries may also be associated with time-to-live parameters that operate in coordination with a related TTL prediction system.

In some embodiments, the system maintains correctness of cached entries when write queries are received. For each cached read query, the system determines whether the write query invalidates the cached entry. This may include recognizing historically invalidating read-write combinations, employing probabilistic reasoning such as Bayesian aggregation, or executing a longform invalidation analysis based on query slices comprising accessed tables, columns, and conditions. Invalidation marks entries as stale. In some embodiments, in response to determining that the entry is likely to be reused, the system retains the stale entries in cache for refresh upon reuse. In some embodiments, in response to determining that the entry is unlikely to be reused, the system evicts the entries to remove entries from cache, such as non-repeating templates or queries that have exceeded thresholds of repetitions or time. Eviction may occur in response to write queries or on periodic intervals. By distinguishing invalidation from eviction and applying intelligent eviction strategies, the system ensures correctness while optimizing limited cache resources.

### BRIEF DESCRIPTION OF THE DRAWINGS

FIG. 1 illustrates an example environment in which a Database Optimization (DBO) system of the present disclosure may operate, in accordance with one or more embodiments.

FIG. 2 illustrates an example architecture of the DBO system, in accordance with one or more embodiments.

FIG. 3 illustrates an example query parsing process implemented by the DBO system, in accordance with one or more embodiments.

FIG. 4 illustrates an example read query handling process implemented by the DBO system, in accordance with one or more embodiments.

FIG. 5A illustrate an example invalidation process implemented by the DBO system for handling write queries, in accordance with one or more embodiments.

FIG. 5B illustrates an example eviction process implemented by the DBO system for cleaning up cached entries, in accordance with one or more embodiments.

FIG. 6 is a flowchart of a method for database optimization during processing of read queries, in accordance with one or more embodiments.

FIG. 7 is a flowchart of a method for database optimization during processing of write queries, in accordance with one or more embodiments.

FIG. 8 is a block diagram of an example computer suitable for use in a networked computing environment, in accordance with one or more embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

Conventional database caching systems suffer from several limitations. As an example, they typically apply simple least-recently-used (LRU) eviction policies and indiscriminately cache all incoming queries. Notably, LRU policies exhibit a recency bias, which can evict queries with slower repetition cycles even though they are repeatedly used and resource-intensive to execute. This leads to wasted cache capacity on one-time or unstable queries that are unlikely to repeat, displacing queries that would provide higher performance benefit if cached. Further, when write queries occur, conventional systems lack mechanisms for determining which cached read queries are affected. Existing approaches either over-invalidate—discarding large portions of the cache unnecessarily—or under-invalidate, risking the return of stale or incorrect results. Yet further, traditional systems fail to distinguish between invalidation and eviction. Treating these stale records uniformly causes premature removal of valuable queries and further reduces cache efficiency.

A Database Optimization (DBO) system disclosed herein addresses these problems by introducing query-aware cache management. The system determines whether an incoming read query is cacheable before inserting it into the cache, using statistical rules or machine learning models trained on features such as query templates, repetition patterns, payload stability, execution cost, and payload size. This ensures that limited cache space is reserved for queries with the greater performance benefit.

When a write query is received, the system intelligently invalidates only those cached entries that may be affected, relying on historical read-write interactions, probabilistic reasoning such as Bayesian aggregation, or analysis of query slices including tables, columns, and filter conditions. The system further distinguishes invalidation from eviction: invalidation marks an entry stale while retaining it for refresh, whereas eviction removes entries based on template repetition, repetition count, or elapsed time. Eviction routines may operate in event-based or periodic modes, and incorporate predictive models to overcome the recency bias of LRU caches. Together, these improvements reduce database load, lower query latency, preserve correctness of returned results, and achieve more efficient utilization of cache resources.

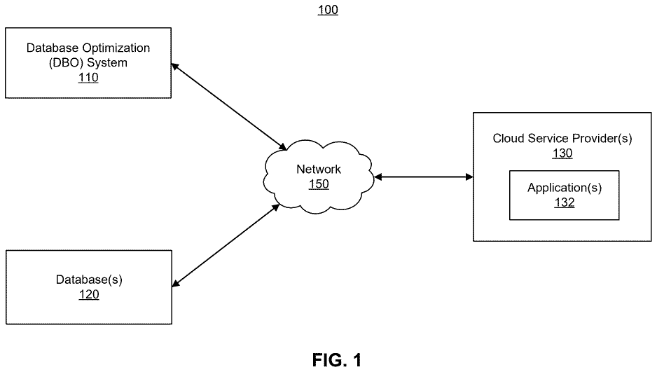

Additional details about the DBO system are further described below with respect to FIGS. 1-8.

### Example System Environment

FIG. 1 illustrates an example environment 100 in which a DBO system 110 of the present disclosure may operate, in accordance with one or more embodiments. The environment 100 includes the DBO system 110, one or more databases 120, one or more cloud service providers 130 hosting one or more applications 132, and a network 150 communicatively coupling these components.

The cloud service provider(s) 130 may host computing resources and services utilized by applications 132. The applications 132 may generate database queries, including read queries and write queries, in the course of operation. These queries are transmitted over the network 150 toward the database(s) 120. In some embodiments, the applications 132 may execute within an orchestration system that manages deployment and scaling of containerized services. For example, the applications 132 may run in a Kubernetes cluster or a similar orchestration environment.

The database(s) 120 may include relational databases, non-relational databases, or other structured or semi-structured data stores. In some embodiments, the database(s) 120 may be implemented as part of a data warehouse environment. In such embodiments, the databases 120 may store large volumes of structured or semi-structured data and support analytical queries. The database(s) 120 store records and respond to queries received via the network 150.

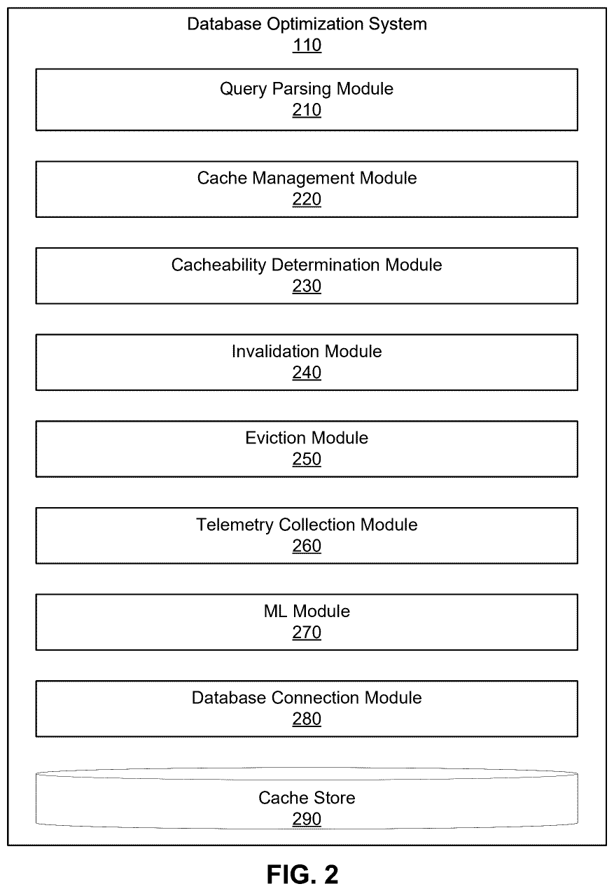

The DBO system 110 is interposed in the communication path between the applications 132 and the database(s) 120. The DBO system 110 operates as a middleware component configured to intercept queries issued by applications 132. The DBO system 110 implements caching, invalidation, and eviction processes for improving database query performance. In some embodiments, the DBO system 110 determines whether a received query is a read query or a write query, consults or updates a cache of query results accordingly, and coordinates with the database(s) 120 to maintain data correctness and consistency. Additional details about the DBO system 110 are further described below with respect to FIG. 2.

The network 150 may include any suitable communication infrastructure such as the Internet, local area networks, or cloud-based interconnects. The network 150 may include any suitable communication infrastructure supporting data exchange between the applications 132, the DBO system 110, and the databases 120. For example, the network 150 may comprise a local area network (LAN), a wireless local area network (WLAN), or a wide area network (WAN). In some embodiments, the network 150 may further include wireless communication technologies such as 3G, 4G, 5G, or other cellular data networks, as well as the public Internet or private cloud-based interconnects.

In operation, an application 132 issues a query via the cloud service provider 130. The query is received by the DBO system 110. The DBO system 110 determines whether the query is a read query or a write query. In response to determining that the query is a read query, the DBO system 110 determines whether the query can be served from a cache or whether it should be forwarded to the database(s) 120 for execution. In response to determining that the query is a write query, the DBO system 110 initiates invalidation or eviction routines to ensure cached results remain consistent with the updated database contents. The DBO system 110 returns either the result of an executed query or a cached query result to the requesting application 132 via the network 150.

FIG. 2 illustrates an example architecture of the DBO system 110, in accordance with one or more embodiments. The DBO system 110 includes a query parsing module 210, a cache management module 220, a cacheability determination module 230, an invalidation module 240, an eviction module 250, a telemetry collection module 260, a machine learning module 270, a database connection module 280, and a cache store 290. In various embodiments, the system may include additional modules, omit certain modules, or implement the described functions by combining multiple modules into a single module or distributing a single module's functions across multiple modules.

The query parsing module 210 receives incoming queries from client applications and determines whether each query is a read query (e.g., DQL) or a write query (e.g., DML). DQL refers to Data Query Language statements, which retrieve information from a database, such as SELECT operations used to read data without altering it. DML refers to Data Manipulation Language statements, which modify the contents of a database, such as INSERT, UPDATE, or DELETE operations.

In some embodiments, the query parsing module 210 may further parse query templates to extract structural components of the query, including one or more tables referenced by the query, the specific columns accessed within those tables, and/or any filter conditions such as predicates or WHERE clause constraints. The extracted components may be provided as structured metadata to other modules of the DBO system 110 for subsequent evaluation.

The cache management module 220 is configured to coordinate retrieval, validation, and storage of query results in the cache. For read queries, the cache management module 220 may determine whether a valid cached result exists. In response to determining that the valid cache result exists, the cache management module 220 returns the cache result to the requesting application without forwarding the query to the database. In response to determining that a cached entry exists but has been marked invalid, the cache management module 220 may forward the read query to the database, receive a refreshed result, update the cache with the refreshed result, and then return the refreshed result to the requesting application. In response to determining that no cached entry exists, the cache management module 220 may determine whether the query is cacheable in coordination with the cacheability determination module 230. In response to determining that the query is cacheable, the cache management module 220 may add the result to the cache, subject to space availability and eviction policies. In this manner, the cache management module 220 ensures that cached results are served when valid, refreshed when invalid, and selectively added to the cache to optimize query latency and backend database load.

The cacheability determination module 230 determines whether a received read query should be stored in the cache. In some embodiments, the cacheability determination module 230 may use the tables and columns extracted by the query parsing module 210 to assess potential overlap with previously cached queries. In some embodiments, the cacheability determination module 230 may use the extracted tables and columns associated with a write query to assess potential overlap with previously cached queries. In some embodiments, this decision may be based on factors including query repetition frequency, consistency of payloads, execution cost, and predicted future reuse. In some embodiments, this decision may be based on machine learning models trained by the machine learning module 270 on historical query traffic.

The invalidation module 240 is configured to determine whether a cached read query should be marked invalid. In some embodiments, the determination is performed in response to a received write query. In response to receipt of a write query, the invalidation module 240 identifies one or more cached read queries that may be affected by the write query. In some embodiments, the invalidation module 240 cooperates with the query parsing module 210 to decompose the write query into ‘slices’ representing accessed tables, referenced columns, and filter conditions. By comparing these slices with the structural components of cached read queries, the invalidation module 240 can determine whether the write query modifies a portion of the database that overlaps with data relied upon by a cached result, and accordingly invalidate the affected cached entry.

In some embodiments, the invalidation module 240 may determine whether a cached entry is to be invalidated by referencing a predicted time-to-live (TTL) value associated with the entry. The TTL may be determined using statistical analysis of query repetition intervals and payload stability, or alternatively by machine learning models trained on historical query traffic by the machine learning module 270. Assigning TTL values in this manner enables the system to maintain cached entries for an optimized duration, thereby reducing unnecessary early expirations while also mitigating the risk of returning stale results.

The eviction module 250 is configured to evaluate cached entries based on eviction criteria and to delete entries that satisfy eviction criteria. The eviction criteria may include conditions such as cache capacity limits, expiration of an expected lifetime or repetition threshold, or predictions indicating low probability of future reuse. In some embodiments, the eviction module 250 determines whether a stale cached entry should be removed by applying machine learning models trained on historical query traffic by the machine learning module 270. This approach enables targeted eviction decisions that prioritize retention of entries with higher expected utility while freeing space from entries with minimal projected benefit.

It should be noted that invalidation and eviction are distinct operations. Invalidation marks a cached entry as stale so that it may be refreshed upon a subsequent request, but does not remove the entry from the cache. Eviction, by contrast, removes the entry to free capacity for new queries. Thus, invalidation does not imply eviction, and many invalidated entries may remain in the cache awaiting refresh.

Traditional least-recently-used (LRU) eviction policies exhibit a recency bias that can prematurely remove queries with slower repetition cycles whenever the cache is under heavy load from fresh queries. The disclosed system mitigates this problem by incorporating query repetition statistics and predicted reuse likelihood into eviction decisions, thereby retaining valuable queries that would otherwise be evicted under strict recency-based policies.

The telemetry collection module 260 is configured to monitor and record operational data related to query processing and cache performance. Such telemetry may include raw query traffic, cache hit and miss events, invalidation operations, eviction decisions, and observed query repetition patterns. Additional metadata such as execution times, payload sizes, processing load, and query templates may also be captured. The collected telemetry provides a historical dataset that serves as the basis for statistical analyses, including calculation of repetition intervals, payload stability metrics, and cache utility estimates. In some embodiments, this telemetry is further supplied to the machine learning module 270 for training and refinement of predictive models used in cacheability classification, TTL estimation, invalidation prediction, and eviction decision-making. By maintaining a comprehensive record of system activity, the telemetry collection module 260 enables continuous adaptation and optimization of cache management policies.

The machine learning (ML) module 270 applies machine learning techniques to train ML models for predicting cacheability of queries and likelihood of invalidation. Features may include query templates, payload stability, historical access frequency, and user-specific traffic patterns. Predictions from the ML Module 270 can inform the cacheability determination module 230, the invalidation module 240, and the eviction module 250.

In some embodiments, the ML module 270 may process SQL query templates using natural language processing (NLP) techniques. SQL queries have a defined grammar that allows extraction of structural features, such as joins, filters, and column access patterns. These features can be incorporated into the feature space used by the ML module 270 to improve prediction of cacheability, invalidation likelihood, and reuse probability.

Machine learning predictions may be executed in real time as queries are received, and/or alternatively in batch mode. In the batch mode, predictions are precomputed from historical query traffic and stored in a lookup table, which can be updated periodically. In some embodiments, both real-time and batch modes are implemented. This dual-mode approach allows the system 110 to balance latency requirements with computational resource usage.

In some embodiments, machine learning models may be trained separately for each client to capture highly specific traffic patterns, or alternatively trained across multiple clients to leverage a larger pool of data and improve prediction accuracy. In some embodiments, both approaches are available for the applications 132 and may be selected based on available training data and application requirements.

The database connection module 280 interfaces with the databases 120. Queries are forwarded to the databases when cache misses occur or when invalidated or expired results require refresh. Results received from the databases 120 are passed back to clients and may also be inserted into the cache under control of the cache management module 220.

The cache store 290 holds cached query results along with associated metadata, including validity state (valid, invalidated, or evicted), time-to-live values, query templates, and payloads. The cache store 290 may support rapid lookup, update, and removal operations.

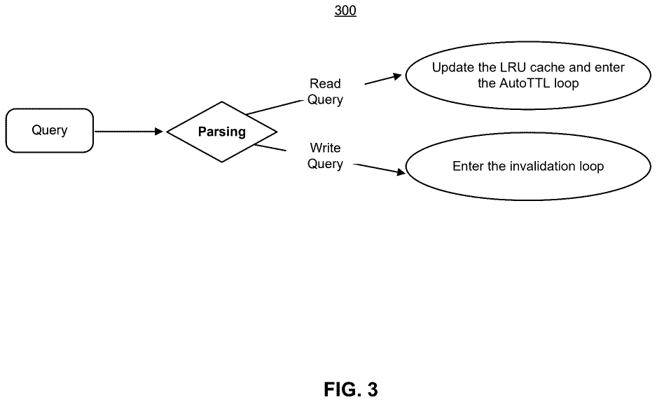

FIG. 3 illustrates an example query parsing process 300 implemented by the DBO system, in accordance with one or more embodiments. As shown in FIG. 3, a query is received by the DBO system. The query may originate from a client application. The query is provided to a parsing stage (e.g., performed by the query parsing module 210), where the query is analyzed to determine its type, which includes either a read query (e.g., DQL) or a write query (e.g., DML). DQL refers to Data Query Language statements, which retrieve information from a database, such as SELECT operations used to read data without altering it. DML refers to Data Manipulation Language statements, which modify the contents of a database, such as INSERT, UPDATE, or DELETE operations.

When the query is identified as a DQL (read) query, the system updates a least-recently-used (LRU) cache and enters an AutoTTL process. The AutoTTL loop is a process that dynamically manages the validity of cached query results by monitoring their refresh time and associated time-to-live (TTL) value. Each time a cached entry is accessed or refreshed, the AutoTTL loop updates the TTL parameters to extend validity, ensuring frequently reused queries remain available while stale or unused entries naturally expire.

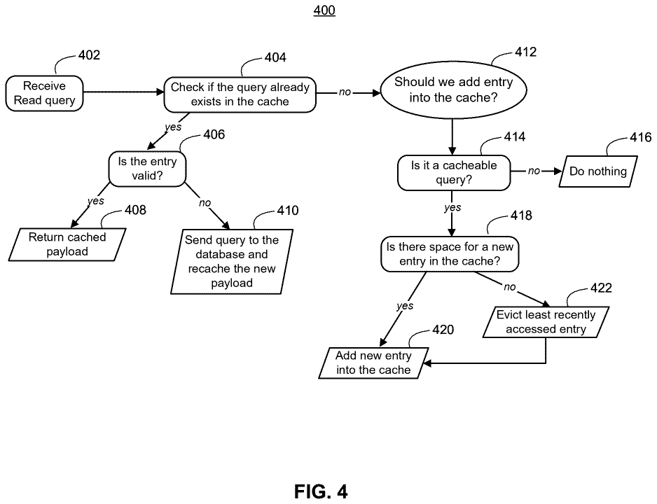

In some embodiments, during this process, the system determines whether the read query result can be served from an existing cache entry. If a valid entry is found, the system returns the cached result. If no entry exists or the entry has been invalidated, the system forwards the query to the database, obtains the result, stores the result in the cache, determines a time-to-live (TTL) value for the result, and records the TTL as metadata associated with the cached entry. Additional details about processing of read query are further described below with respect to FIG. 4.

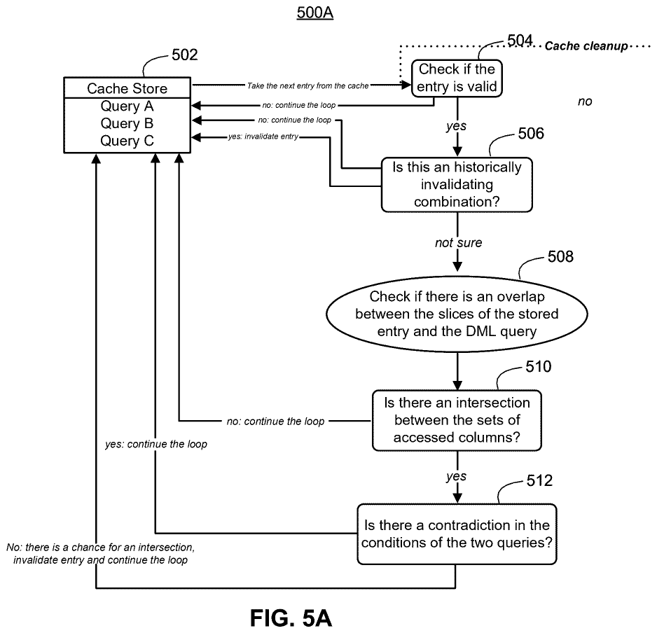

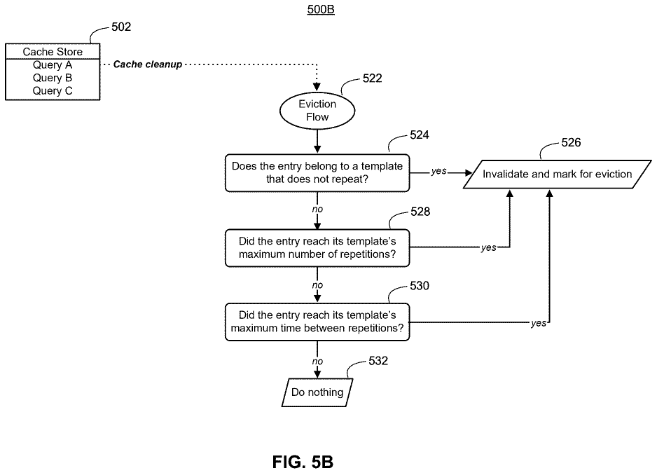

If the query is determined to be a DML (write) query, control proceeds to enter an invalidation loop for each cached read query. In this path, the system evaluates each cached read query to determine whether their results are potentially affected by the write operation. Impacted cache entries may be invalidated so that stale results are not returned to future read queries. Additional details about processing of write queries are further described below with respect to FIGS. 5A-5B.

### Example Read Query Handling Process

FIG. 4 illustrates an example read query handling process 400 implemented by the DBO system, in accordance with one or more embodiments. The process 400 begins when the system receives a DQL query (step 402). At step 404, the system checks whether the query already exists in the cache. In response to determining that the query exists in the cache (yes), the system proceeds to step 406 and evaluates whether the entry is valid. In response to determining that the cached entry is valid (yes), the system returns the cached payload to the client (step 408), thereby reducing query latency and avoiding execution at the database. In response to determining that the cached entry is invalid (no), the system forwards the query to the database, obtains a new payload, and recaches the new payload (step 410).

If the query does not exist in the cache (no), the system proceeds to step 412, where it determines whether the query should be added to the cache. At step 414, the system evaluates cacheability of the query. This determination may be based on statistical rules or machine learning predictions using factors such as repetition frequency, payload stability, and execution cost. In response to determining that the query is not cacheable (no), the system takes no further caching action (step 416), and the query is executed against the database without caching.

In some embodiments, the cacheability decision may further incorporate additional factors such as the size of the query payload, the computational cost of executing the query, and the processing load imposed on the database. By prioritizing caching of queries with high execution cost or large payloads, the system maximizes performance gains and compute resource savings for clients.

In response to determining that the query is determined to be cacheable (yes), the system proceeds to step 418 to determine whether there is available space in the cache. In response to determining that space is available (yes), the system adds the new entry into the cache (step 420). In response to determining that the cache is full (no), the system invokes an eviction policy (step 422), such as removing the least recently accessed entry, before proceeding to add the new entry into the cache (step 420).

Through the sequence of operations shown in process 400, the DBO system selectively caches only queries that provide performance benefit, ensures cache entries remain valid, and applies intelligent eviction policies to optimize limited cache resources.

### Example Write Query Handling Process

FIG. 5A illustrate an example invalidation process 500A implemented by the DBO system for handling write queries, in accordance with one or more embodiments.

As shown in FIG. 5A, entries are iteratively taken from a DQL cache (block 502, which corresponds to the cache store 290 in FIG. 2) containing stored read queries (e.g., Query A, Query B, Query C). For each entry, the system first checks whether the entry is valid (step 504). In response to determining that the entry is already invalid (no), the system continues to the next entry in the cache store 502. In response to determining that the entry is valid (yes), the system determines whether the current read-write query pair corresponds to a historically invalidating combination (step 506). In response to determining that such historical invalidation combination exists (yes), the entry is invalidated, and the system continues to the next entry in the cache store 502. In response to determining that such historical invalidation combination does not exist (no), the entry is kept as valid, and the system also continues to the next entry in the cache store 502.

In some situations, the system is not sure whether such a historical invalidation combination exists. In such a case, the system checks whether there is an overlap between the slices of the stored entry and the DML query (step 508). Slices represent subsets of accessed tables, columns, and conditions associated with the query. The system also determines whether there is an intersection between sets of accessed columns (step 510). In response to determining that no intersection exists (no), the system continues to the next entry in the cache store 502. In response to determining that an intersection exists (yes), the system further checks whether there is a contradiction in the conditions of the two queries (step 512), where the two queries are the cached read query (currently being checked) and the write query being processed for potential invalidation impact. For example, the system checks whether the filter conditions (e.g., WHERE clauses, predicates) in the cached read query contradict those in the write query.

In response to detecting a contradiction (yes), the system concludes the write query does not affect the cached entry, the cached entry remain valid, and the system continues to the next entry in the cache store 502. In response to detecting no contradiction (no), the system invalidates the entry because there is a potential for overlap in the underlying data, and the system continues to the next entry in the cache store 502.

As illustrated in FIG. 5A, when a write query is received, the process is applied iteratively to each entry in the cache to determine whether the entry should be invalidated or retained as valid. For example, assume that the cache store 502 contains three stored read queries, namely Query A, Query B, and Query C. Query A retrieves all records from a SensorData table where the SensorID equals five. Query B retrieves all records from the SensorData table where the Timestamp is later than Jan. 1, 2023. Query C retrieves all records from a Device table where the Region is equal to ‘US.’ When an incoming write query is received, such as an update to the SensorData table that sets a Status field to ‘Active’ for a specific RecordID equal to 101, the system applies the invalidation process of FIG. 5A iteratively to each cached entry:

For Query A, the system determines that the accessed tables overlap, that the columns SensorID and RecordID both belong to the SensorData table, and that there is no contradiction in conditions because the specified record may correspond to the sensor with SensorID equal to five. Accordingly, cached result of Query A is invalidated.

For Query B, the system determines that the accessed table also overlaps with the write query, that the columns Timestamp and RecordID are both attributes of the SensorData table, and that there is no contradiction in conditions because the updated record may have a timestamp later than Jan. 1, 2023. Accordingly, the cached result of Query B is invalidated.

For Query C, the system determines that the accessed tables differ, as the read query involves the Device table while the write query involves the SensorData table, and that there is therefore no intersection in accessed columns. Accordingly, the cached result of Query C is retained as valid.

FIG. 5B illustrates an example eviction process 500B implemented by the DBO system for evicting cached entries, in accordance with one or more embodiments. In some embodiments, the eviction process 500B is applied to each invalidated entries determined by the invalidation process 500A. Alternatively, the eviction process 500B may be applied to each entry (including both valid and invalidated entries) in the cache store.

As illustrated, the eviction flow (block 522) begins by determining whether a cache entry belongs to a template that does not repeat (step 524). A template refers to the structural form of a query with parameter values removed, such that multiple queries differing only in specific parameter inputs are recognized as instances of the same template. For example, queries such as SELECT * FROM SensorData WHERE SensorID=5 and SELECT * FROM SensorData WHERE SensorID=10 are both instances of the template SELECT * FROM SensorData WHERE SensorID=?.”

In response to determining that the template does not repeat (yes), the entry is invalidated and marked for eviction (step 526). In response to determining that the entry belongs to a repeating template (no), the system determines whether the entry has reached its maximum number of repetitions (step 528). The maximum number of repetitions refers to a threshold value representing how many times queries belonging to a particular template are expected to recur before they lose predictive value for caching. This threshold may be determined statistically by analyzing historical query traffic to identify the typical or maximum observed number of repetitions for the template, or it may be specified by a system policy or prediction model. For example, if telemetry indicates that queries of a given template are historically executed no more than ten times before becoming obsolete, the system may set the maximum number of repetitions for that template to ten.

In response to determining that the entry has reached its maximum number of repetitions (yes), the entry is invalidated and marked for eviction (step 526). Otherwise, the system further checks whether the entry has exceeded its maximum time between repetitions (step 530). The maximum time between repetitions refers to a threshold interval representing the longest expected duration between successive executions of queries belonging to a given template. This value may be determined from historical telemetry by measuring the distribution of time gaps between repeated queries of the same template and selecting a maximum observed or statistically derived interval, optionally with a margin to account for variability. If a cached entry has not been re-executed within this interval, the likelihood of future reuse is low.

In response to determining that the entry has exceeded its maximum time between repetitions (yes), the entry is also invalidated and marked for eviction (step 526). For example, if a template is historically repeated at least once every thirty minutes, and a cached instance has not recurred for over 30 minutes plus a safety margin (e.g., 15 minutes), the system considers the entry to have exceeded its maximum time between repetitions and designates it for eviction. In response to determining that the entry does not reach its template maximum time between repetitions (no), the system takes no eviction action for that entry (step 532).

For example, assume that the cache store 502 contains three cached read queries, namely Query A, Query B, and Query C. When the eviction process 500B is applied, the system evaluates Query A and determines that it belongs to a repeating template. The system consults telemetry and determines that queries of this template typically recur no more than ten times before becoming obsolete. Because Query A has already been repeated ten times, the system concludes that it has reached its maximum number of repetitions and marks the entry for eviction at step 526.

The system also evaluates Query B and determines that it belongs to a repeating template and has not yet reached its maximum number of repetitions. However, telemetry indicates that queries of this template historically recur at least once every thirty minutes, and the cached entry has not been re-executed for over 45 minutes. As a result, the system determines that the entry has exceeded its maximum time between repetitions and also marks the entry for eviction at step 526. Through this process, cache entries that are unlikely to provide further performance benefit are removed, thereby freeing space for queries with higher expected utility.

The system then evaluates Query C and identifies that its template typically recurs approximately every 10 minutes and often exceeds 50 repetitions. In the present instance, Query C has repeated only 10 times, with the most recent repetition occurring about 5 minutes earlier. Accordingly, at step 526 the entry is designated as not subject to eviction.

The eviction process 500B enables targeted removal of cache entries based on statistical indicators of query utility, rather than relying solely on least-recently-used policies. By considering repetition counts and time-based thresholds, the DBO system prioritizes retention of queries with higher likelihood of reuse and more efficient cache utilization.

Eviction routines may be invoked either in response to specific events, such as receipt of a write query, or periodically at predetermined intervals. Event-based eviction ensures responsiveness to changes in workload, while periodic eviction provides a background clean-up process that maintains cache efficiency without tying eviction strictly to query traffic.

### Example Methods for Database Optimization During Processing of Read and Write Queries

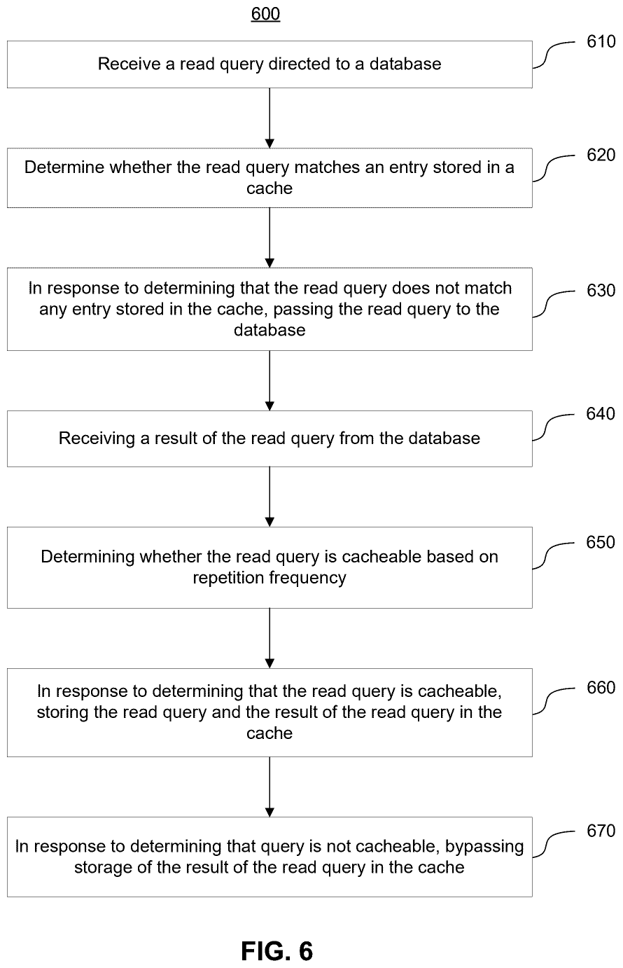

FIG. 6 is a flowchart of a method 600 for database optimization during processing of read queries, in accordance with one or more embodiments. In various embodiments, the method includes different or additional steps than those described in conjunction with FIG. 6. Further, in some embodiments, the steps of the method may be performed in different orders than the order described in conjunction with FIG. 6. The method described in conjunction with FIG. 6 may be carried out by the database optimization system 110 in various embodiments, while in other embodiments, the steps of the method are performed by any online system capable of performing these steps.

The system receives 610 a read query directed to a database. In operation, client applications issue queries to retrieve information from one or more backend databases. These queries may include requests for data contained in relational tables, semi-structured sources, or data warehouse environments. The DBO system functions as an intermediary, intercepting such queries before they are executed directly against the database.

The system determines 620 whether the read query matches an entry stored in a cache. In some embodiments, in response to receipt of the query, the cache management module 220 accesses the cache store to perform a lookup using the query's normalized template and associated parameters. Normalization ensures that logically equivalent queries are matched regardless of syntactic differences. If a matching cached entry exists, the system further checks the validity state of the entry, confirming whether the entry is marked valid or invalid. This determination ensures that only valid results are returned.

In response to determining that the read query does not match any entry stored in the cache, the system passes 630 the read query to the database. This operation ensures that the client's request is fulfilled even when the cache does not currently contain a valid result. In some embodiments, the DBO system forwards the query to the database via the database connection module 280, which manages communication over the network. The database executes the query against its stored records and prepares the result for return. The database thus remains the authoritative source of truth when the cache is unable to serve the requested information.

The system receives 640 a result of the read query from the database. After execution by the database, the query result, which may include rows of relational data or structured payloads, is returned to the DBO system. In some embodiments, the database connection module 280 captures this result and routes it into the cache management module 220 for subsequent processing. At this point, the system may deliver the result directly back to the requesting application.

The system determines 650 whether the read query is cacheable based on repetition frequency. In some embodiments, this determination is further based on one or more of: stability of payloads, execution cost, payload size, or processing load. In some embodiments, the cacheability assessment is performed by the cacheability determination module 230, which applies statistical analysis or machine learning models trained on historical query traffic. Repetition frequency ensures that queries which recur are prioritized for caching. Payload stability reflects whether results remain consistent across executions, which prevents wasteful caching of unstable data. Execution cost and processing load identify queries that impose heavy burden on the backend database, making them strong candidates for caching. Payload size balances the benefit of caching against storage constraints. By considering these factors individually and in combination, the system ensures that cache capacity is reserved for high-value queries. This approach differentiates the disclosed system from traditional least-recently-used caches, which fail to distinguish between cacheable and non-cacheable entries.

In response to determining that the read query is cacheable, the system stores 660 the read query and the result of the read query in the cache. This may include creating a cache entry that associates the query template, input parameters, result payload, and metadata such as validity state, insertion time, and time-to-live (TTL). The TTL may be predicted based on historical repetition intervals or machine learning models, ensuring that the entry remains valid for an optimized duration. In some embodiments, the cache management module 220 writes the entry into the cache store 290, while the eviction module 250 ensures that sufficient capacity is available, possibly removing lower-value entries. Once cached, subsequent queries matching the same template can be served directly from cache without database access, reducing latency and resource consumption. This selective caching mechanism thus improves overall performance, preserves database capacity, and ensures clients receive responses rapidly for frequently repeated and resource-intensive queries.

In response to determining that query is not cacheable, the system bypasses 670 storage of the result of the read query in the cache. In this case, the result is still returned to the requesting application to satisfy the query, but no cache entry is created. Bypassing prevents wasteful use of cache space for queries that are unlikely to recur, queries whose results change frequently, or queries with payloads too large to justify storage. This selective non-caching approach improves cache efficiency compared to systems that indiscriminately store every result. By refraining from caching low-utility queries, the system reduces the rate of cache churn, lowers eviction pressure, and ensures that valuable queries remain in cache longer. This embodiment directly addresses inefficiencies in conventional caching strategies.

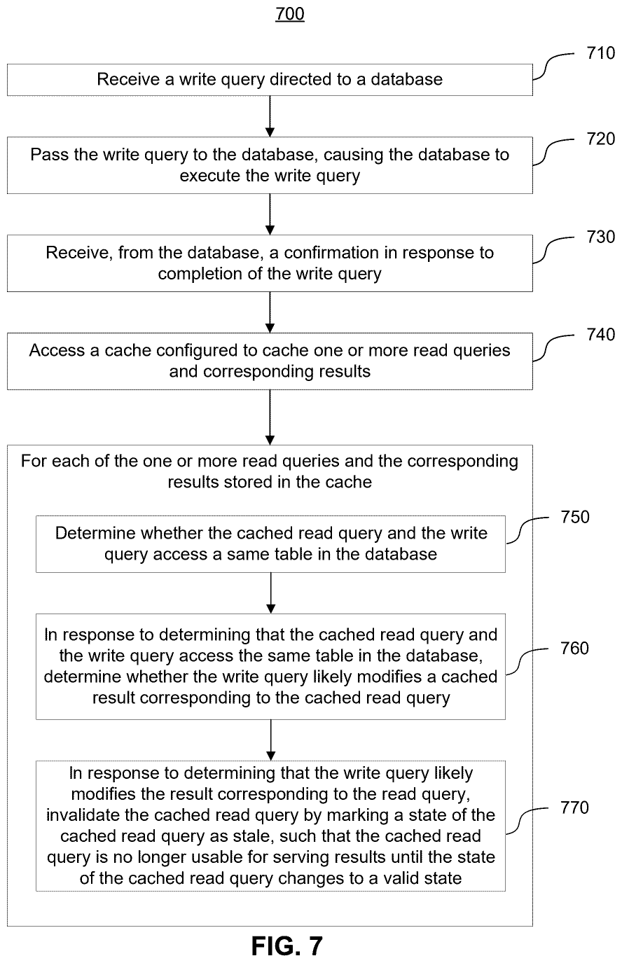

FIG. 7 is a flowchart of a method 700 for database optimization during processing of write queries, in accordance with one or more embodiments. In various embodiments, the method includes different or additional steps than those described in conjunction with FIG. 7. Further, in some embodiments, the steps of the method may be performed in different orders than the order described in conjunction with FIG. 7. The method described in conjunction with FIG. 7 may be carried out by the DBO system 110 in various embodiments, while in other embodiments, the steps of the method are performed by any online system capable of performing these steps.

The system receives 710 a write query directed to a database. Write queries may include Data Manipulation Language (DML) statements such as INSERT, UPDATE, or DELETE operations that modify the contents of one or more tables. The DBO system intercepts such queries as they are issued by client applications, functioning as middleware positioned between the application tier and the backend database. By receiving write queries before they reach the database, the system is able to analyze their potential impact on cached read queries. This interception ensures that any modifications to the underlying data can be accounted for within the cache, thereby preserving correctness of responses returned to clients. Receipt of write queries thus serves as the trigger point for initiating invalidation and eviction processes, distinguishing the disclosed system from conventional caches that do not actively account for the impact of write traffic.

The system passes 720 the write query to the database, causing the database to execute the write query. In some embodiments, the DBO system forwards the write query to the database through the database connection module 280. The database processes the requested operation, updating its stored records according to the commands contained in the query. For example, an update query may change the value of one or more columns in a targeted table, while an insert query adds new rows.

The system receives 730, from the database, a confirmation in response to completion of the write query. In response to executing the requested query, the database returns an acknowledgment to the DBO system. This confirmation may include transaction success indicators, error codes, or metadata about the affected rows. The DBO system uses this confirmation as a signal to proceed with cache maintenance routines, including invalidation and eviction analysis.

The system accesses 740 a cache configured to cache one or more read queries and corresponding results. The cache may be implemented as a dedicated memory store (e.g., cache store 290) or distributed caching layer managed by the cache management module 220. In some embodiments, each entry in the cache includes a read query template, associated parameters, result payload, and metadata describing validity state, insertion time, and time-to-live (TTL).

For each of the one or more read queries and the corresponding results stored in the cache, the system determines 750 whether the cached read query and the write query access a same table in the database. This determination may be based on analyzing the query templates and identifying tables referenced in both the read and write operations. If the queries target entirely distinct tables, the system concludes that the write query cannot affect the cached result, and the entry remains valid. If the same table is accessed, however, the system marks the cached entry as potentially affected and subjects it to further analysis. This table-level overlap check provides an efficient filtering mechanism that prevents unnecessary downstream processing. By narrowing focus only to entries that share tables with the write query, the system improves performance while still ensuring that no potentially impacted cached results are overlooked.

In response to determining that the cached read query and the write query access the same table in the database, the system determines 760 whether the write query modifies a cached result corresponding to the cached read query. This determination may involve several techniques, including analyzing whether the write and read queries overlap in referenced columns, comparing filter conditions for contradictions, or consulting historical invalidation patterns. Machine learning models trained on past read-write interactions may also be applied to output a likelihood score that the write query alters the cached result. If probability exceeds a threshold, or if column and condition analysis confirms overlap, the system treats the cached entry as impacted. This staged approach ensures that only queries likely to be affected by the write are invalidated, reducing unnecessary churn in the cache and improving efficiency while maintaining correctness of returned data.

In response to determining that the write query modifies the result corresponding to the rad query, the system invalidates 770 the cached read query by marking a state of the cached read query as stale, such that the cached read query is no longer usable for serving results until the state of the cached read query changes to a valid state. Invalidation does not remove the entry from the cache; instead, it changes its validity flag, preventing stale payloads from being returned to clients. When the next client issues the corresponding read query, the system forwards it to the database, retrieves a fresh result, and refreshes the cache entry, at which point its state reverts to valid. This embodiment ensures correctness of results while avoiding premature eviction. Distinguishing invalidation from eviction allows the system to retain structural knowledge of queries while ensuring that no stale data is served.

### Example Computing System

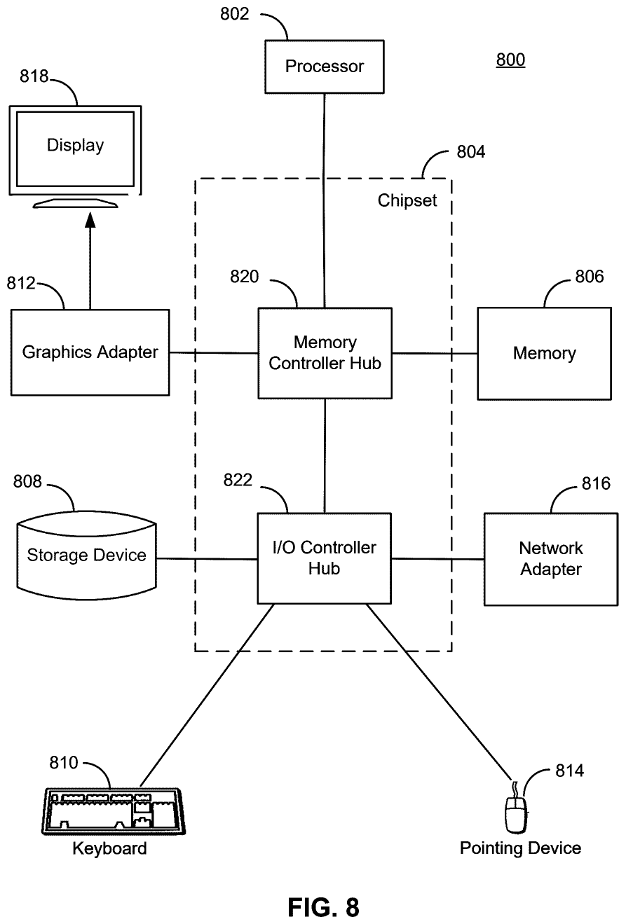

FIG. 8 is a block diagram of an example computer 800 suitable for use in the networked computing environment 100 of FIG. 1. The computer 800 is a computer system and is configured to perform specific functions as described herein. For example, the specific functions corresponding to automation system 110 may be configured through the computer 800.

The example computer 800 includes a processor system having one or more processors 802 coupled to a chipset 804. The chipset 804 includes a memory controller hub 820 and an input/output (I/O) controller hub 822. A memory system having one or more memories 806 and a graphics adapter 812 are coupled to the memory controller hub 820, and a display 818 is coupled to the graphics adapter 812. A storage device 808, keyboard 810, pointing device 814, and network adapter 816 are coupled to the I/O controller hub 822. Other embodiments of the computer 800 have different architectures.

In the embodiment shown in FIG. 8, the storage device 808 is a non-transitory computer-readable storage medium such as a hard drive, compact disk read-only memory (CD-ROM), DVD, or a solid-state memory device. The memory 806 holds instructions and data used by the processor 802. The pointing device 814 is a mouse, track ball, touchscreen, or other types of a pointing device and may be used in combination with the keyboard 810 (which may be an on-screen keyboard) to input data into the computer 800. The graphics adapter 812 displays images and other information on the display 818. The network adapter 816 couples the computer 800 to one or more computer networks, such as network 150.

The types of computers used by the entities and the automation system 110 of FIGS. 1 through 8 can vary depending upon the embodiment and the processing power required by the enterprise. For example, the automation system 110 might include multiple blade servers working together to provide the functionality described. Furthermore, the computers can lack some of the components described above, such as keyboards 810, graphics adapters 812, and displays 818.

### Additional Considerations

The embodiments described herein provide technical advantages over conventional database caching systems by introducing query-aware mechanisms for cacheability, invalidation, and eviction. Unlike traditional least-recently-used approaches that indiscriminately cache all queries and evict entries based solely on recency, the disclosed system selectively caches only those queries predicted to provide meaningful performance benefits, using statistical rules and machine learning models trained on features such as repetition frequency, payload stability, execution cost, payload size, and processing load. On the write side, the system applies intelligent invalidation by analyzing table and column overlaps, filter condition contradictions, historical interaction patterns, and probabilistic model outputs to invalidate only those cached results truly at risk of becoming stale. This reduces unnecessary churn in the cache while preserving correctness. By further distinguishing invalidation from eviction and employing predictive eviction strategies, the system mitigates recency bias, retains high-value queries, and optimizes cache utilization, resulting in reduced database load, lower query latency, and more efficient resource consumption.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcodes, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for selectively caching results of read queries in a database optimization system, the method comprising:
receiving a read query directed to a database;
determining whether the read query matches an entry stored in a cache;
in response to determining that the read query does not match any entry stored in the cache, passing the read query to the database;
receiving a result of the read query from the database;
determining whether the read query is cacheable based on repetition frequency;
in response to determining that the read query is cacheable, storing the read query and the result of the read query in the cache thereby avoiding accessing the database upon receipt of the read query in a future request; and
in response to determining that query is not cacheable, bypassing storage of the result of the read query in the cache.

2. The method of claim 1, wherein determining whether the read query is cacheable is further based on one or more of: stability of payloads, execution cost, payload size, or processing load.

3. The method of claim 1, further comprising:
in response to determining that the read query matches an entry stored in the cache,
determining whether the result of the read query stored in the cache is valid; and
in response to determining that the result of the read query stored in the cache is valid, retrieving the result of the read query from the cache.

4. The method of claim 3, wherein determining whether the result of the read query stored in the cache is valid includes:
determining a time-to-live value of the entry corresponding to the read query stored in the cache;
determining whether the time-to-live value of the entry is expired; and
in response to determining that the time-to-live value of the entry is expired, determining that the result of the read query stored in the cache is invalid.

5. The method of claim 4, further comprising:
in response to determining that the result of the read query stored in the cache is invalid,
passing the read query to the database;
receiving the result of the read query from the database; and
refreshing the result of the read query stored in the cache with the received result of the read query from the database.

6. The method of claim 5, wherein refreshing the result of the read query stored in the cache with the received result of the read query from the database comprises:
determining a time-to-live value for the result of the read query; and
storing, as metadata with the cached result, a refresh timestamp corresponding to a most recent refreshing of the result, wherein the refresh timestamp defines a reference point from which the time-to-live value is measured to determine validity of the cached result.

7. The method of claim 6, wherein determining the time-to-live value of the result of the read query includes:
applying a machine learning model trained on data describing historical queries to output a value indicating a predicted time-to-live value.

8. The method of claim 1, wherein determining whether the read query is cacheable includes:
applying a machine learning model trained on data describing historical queries to output a cacheability score indicating whether the read query is cacheable; and
in response to determining that the cacheability score is greater than a threshold, determining that the read query is cacheable.

9. The method of claim 1, further comprising:
before storing the result of the read query in the cache,
determining whether the cache is full;
in response to determining that the cache is full, identifying an entry in the cache based on a probability of reuse of the entry or a recency of access; and
removing the identified entry from the cache.

10. A non-transitory computer readable storage medium having instructions encoded thereon that, when executed by one or more processors, cause the one or more processors to perform steps comprising:
receiving a read query directed to a database;
determining whether the read query matches an entry stored in a cache;
in response to determining that the read query does not match any entry stored in the cache, passing the read query to the database;
receiving a result of the read query from the database;
determining whether the read query is cacheable based on repetition frequency;
in response to determining that the read query is cacheable, storing the read query and the result of the read query in the cache thereby avoiding accessing the database upon receipt of the read query in a future request; and
in response to determining that query is not cacheable, bypassing storage of the result of the read query in the cache.

11. The non-transitory computer readable storage medium of claim 10, wherein determining whether the read query is cacheable further based on one or more of: stability of payloads, execution cost, payload size, or processing load.

12. The non-transitory computer readable storage medium of claim 10, the steps further comprising:
in response to determining that the read query matches an entry stored in the cache,
determining whether a result of the read query stored in the cache is valid; and
in response to determining that the result of the read query stored in the cache is valid, retrieving the result of the read query from the cache.

13. The non-transitory computer readable storage medium of claim 12, wherein determining whether the result of the read query stored in the cache is valid includes:
determining a time-to-live value of the entry corresponding to the read query stored in the cache;
determining whether the time-to-live value of the entry is expired; and
in response to determining that the time-to-live value of the entry is expired, determining that the result of the read query stored in the cache is invalid.

14. The non-transitory computer readable storage medium of claim 13, the steps further comprising:
in response to determining that the result of the read query stored in the cache is invalid,
passing the read query to the database;
receiving the result of the read query from the database; and
refreshing the result of the read query stored in the cache with the received result of the read query from the database.

15. The non-transitory computer readable storage medium of claim 14, wherein refreshing the result of the read query stored in the cache with the received result of the read query from the database includes:
determining a time-to-live value for the result of the read query; and
storing, as metadata with the cached result, a refresh timestamp corresponding to a most recent refreshing of the result, wherein the refresh timestamp defines a reference point from which the time-to-live value is measured to determine validity of the cached result.

16. The non-transitory computer readable storage medium of claim 15, wherein determining the time-to-live value of the result of the read query includes:
applying a machine learning model trained on data describing historical queries to output a value indicating a predicted time-to-live value.

17. The non-transitory computer readable storage medium of claim 10, wherein determining whether the read query is cacheable includes:
applying a machine learning model trained on data describing historical queries to output a cacheability score indicating whether the read query is cacheable; and
in response to determining that the cacheability score is greater than a threshold, determining that the read query is chacheable.

18. The non-transitory computer readable storage medium of claim 10, the steps further comprising:
before storing the result of the read query in the cache,
determining whether the cache is full;
in response to determining that the cache is full, identifying an entry in the cache based on a probability of reuse of the entry or a recency of access; and
removing the identified entry from the cache.

19. A system, comprising:
one or more processors; and
a non-transitory computer readable storage medium having instructions encoded thereon that, when executed by the one or more processors, cause the one or more processors to perform steps comprising:
receiving a read query directed to a database;
determining whether the read query matches an entry stored in a cache;
in response to determining that the read query does not match any entry stored in the cache, passing the read query to the database;
receiving a result of the read query from the database;
determining whether the read query is cacheable based on repetition frequency;
in response to determining that the read query is cacheable, storing the read query and the result of the read query in the cache thereby avoiding accessing the database upon receipt of the read query in a future request; and
in response to determining that query is not cacheable, bypassing storage of the result of the read query in the cache.

20. The system of claim 19, the steps further comprising:
in response to determining that the read query matches an entry stored in the cache,
determining whether a result of the read query stored in the cache is valid; and
in response to determining that the result of the read query stored in the cache is valid, retrieving the result of the read query from the cache.
